(19) United States
(12) Patent Application Publication
(10) Pub. No.: US 2007/0024591 A1
(43) Pub. Date: Feb. 1, 2007

(54) Retrofit touch sensor controls

(75) Inventor: Charles David Fry, New Bloomfield, PA (US)

Correspondence Address: Helen Odar Wolstoncroft;Tyco Electronic, Suite 140, 4550 New Linden Hill Road, Wilmington, DE, 19808-2952, US

(73) Assignee: Tyco Electronics Corporation

(21) Appl. No.: 11/190,327

(22) Filed: Jul. 27, 2005

(51) Int. Cl. G09G 5/00

(52) U.S. Cl. 345/173

(57) ABSTRACT

A touch controller for a touch sensitive control system having a control interface panel and a plurality of touch detecting elements is configured to accept a first number of input signals via corresponding input connections; monitor each of said touch detecting elements individually to detect user touch activation thereof; and output signals corresponding to detected touches, wherein a number of output signals is less than a number of touch detecting elements in the interface.

### BACKGROUND OF THE INVENTION

This invention relates generally to touch sensitive control interfaces, and more particularly, to a touch sensor system for use in such interfaces.

Due to their convenience and reliability, touch sensitive control interfaces are increasingly being used in lieu of mechanical switches for various products and devices. Touch sensitive control interfaces are used in a wide variety of exemplary applications such as appliances (e.g., stoves and cooktops), industrial devices such as machine controls, cash registers and check out devices, vending machines, and even toys. The associated device may be finger operated by touching predefined areas of the interface, and the device typically includes a controller coupled to the interface to operate mechanical and electrical elements of the device in response to user commands entered through the touch control interface.

Various types of technologies are available for use in touch control interfaces, including but not limited to touch sensitive elements such as, for example, capacitive sensors and infrared detectors, and switching elements (e.g., membrane switch assemblies) responsive to touch keypads. Membrane switches have been widely used in the past in various products and devices while touch control interfaces are becoming preferred in newer products and devices. Many existing products and devices having membrane switches, however, have a considerable lifespan remaining, and in some applications it would be desirable to replace the membrane switches in such products with more reliable touch-based technologies. Incompatibility between membrane switches and touch based technologies, however, are proving to be a serious impediment to retrofitting of older products and designs with newer touch control technologies

For example, membrane switches typically include a number of intersecting input wires and output wires arranged and electrically connected in a cross matrix, and a touchpad is located at the intersection of each of the wires. Each touchpad is marked with an alphanumeric symbol or indicia, and collectively the touchpads define a user interface in which a user may enter, for example, a product code for a desired purchase in a vending machine device, energize or de-energize operating elements of the device (e.g., heating elements in a cooking appliance interface), adjust operating parameters of the device (e.g., temperature adjustment of a refrigeration device), etc. When a touchpad is touched, a circuit path is completed between the respective input and output wires of the membrane switch that correspond to the touched keypad. A controller pulses the input wires with an input signal, and reads signals from the output wires to detect when the touchpads are touched. The controllers are programmed to respond to the signal readings from the output wires and operate the device accordingly. Typically, multiple keypads correspond to each of the output wires.

Known, touch-based controls, however, relay upon scanning of the individual touchpads or keypads of the system, and detect a signal response from each touchpad to detect touches by a user. U.S. Pat. No. 5,760,715, for example, describes capacitive touch sensors that complete a circuit to earth ground when a user's finger is adjacent the sensor. Thus, these and other types of touch-based sensors produce different numbers and types of signal outputs for a given number of touchpads than do membrane switches. Because the controllers of devices having membrane switch assemblies are programmed to respond to the signal outputs of the membrane switches, touch based sensors are not interchangeable with membrane switch assemblies without having to reprogram the controller of the device. Reprogramming of the controllers for such devices is impractical, and in some cases is cost prohibitive.

Moreover, in certain types of products having membrane switches, it is desirable to simultaneously activate more than one of the keys to enter certain modes of operation for the device, including but not limited to diagnostic or programming modes. Many known touch sensors, however, have a unique output format or require that only one sensor is active at a time, and are consequently are not compatible for intended use requiring detecting simultaneous activation of more than one of the touch sensors.

### BRIEF DESCRIPTION OF THE INVENTION

In one exemplary embodiment, a touch controller for a touch sensitive control system having a control interface panel and a plurality of touch detecting elements is provided. The controller is configured to accept a first number of input signals via corresponding input connections; monitor each of said touch detecting elements individually to detect user touch activation thereof; and output signals corresponding to detected touches, wherein a number of output signals is less than a number of touch detecting elements in the interface.

Optionally, the controller is configured to output signals corresponding to simultaneous activation of multiple touch detecting elements, and is configured to emulate an output control scheme of a membrane switch assembly. The touch sensitive control system may include a device controller, and the touch controller is configured to receive input signals from the device controller, and transmit output signals to the device controller based upon detected touch activations of the touch detecting elements.

In another exemplary embodiment, a control interface for a device having a device controller is provided. The control interface comprises an interface panel defining a plurality of touch sensitive areas, touch sensitive elements associated with each respective one of the touch sensitive areas, and a touch controller individually monitoring each of the touch sensitive elements. The touch controller outputs control signals to the device controller, wherein the touch controller emulates the control output scheme of a membrane switch.

In still another exemplary embodiment, a touch based control system is provided. The system comprises a device having a device controller and a number of components operatively connected thereto, and a control interface communicating with the device controller. The control interface comprises an interface panel defining a plurality of touch sensitive areas, touch sensitive elements associated with each respective one of the touch sensitive areas, and a touch controller individually monitoring each of the touch sensitive elements. The touch controller outputs control signals to the device controller in response to single touch detection activation of one of the touch sensitive elements and simultaneous touch detection of more than one of the touch sensitive elements.

### BRIEF DESCRIPTION OF THE DRAWINGS

FIG. 1 is a schematic block diagram of an exemplary touch sensitive control system for a device.

FIG. 2 is a top plan view of an exemplary control interface for the control system shown in FIG. 1.

FIG. 3 is a virtual schematic illustration of the control interface shown in FIG. 2.

FIG. 4 is a connection schematic of the interface to the device controller shown in FIG. 1.

FIG. 5 is a method flowchart for the control interface shown in FIGS. 3 and 4.

### DETAILED DESCRIPTION OF THE INVENTION

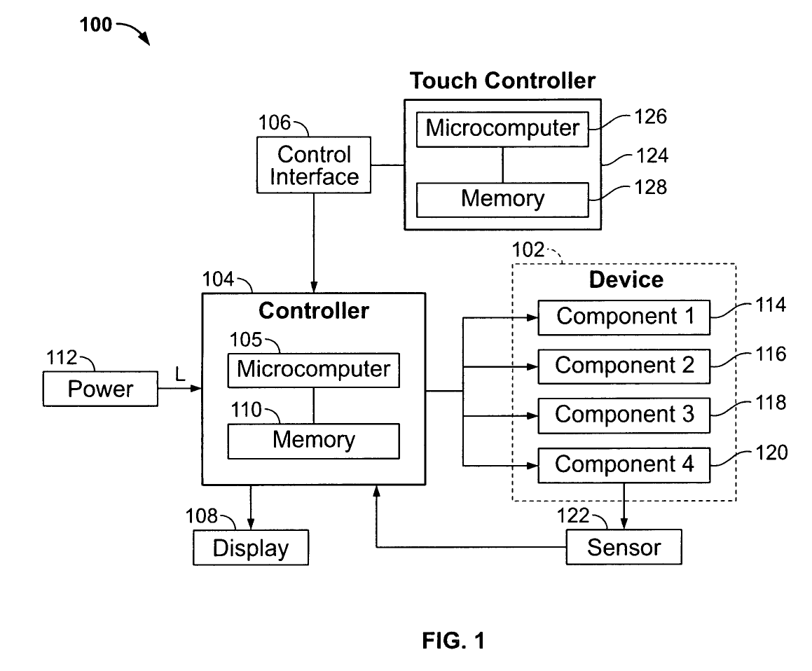

FIG. 1 is a schematic block diagram of an exemplary touch sensitive control system 100 for a device 102, which in various embodiments may be a vending machine, an appliance, an industrial machine, a toy or any other device in which a touch sensitive control interface is desirable. In an exemplary embodiment, the device 102 is retrofitted with touch sensitive controls that replace a membrane switch assembly or another mechanical switching scheme originally provided in or associated with the device 102, although it is contemplated that the touch sensitive controls described hereinafter could be originally provided in the device 102 as desired.

In an exemplary embodiment, the control system 100 includes a controller 104 which may, for example, include a microcomputer or other processor 105 coupled to a user control interface 106 including one or more touch sensitive elements as opposed to switching elements (e.g., a membrane switch assembly having mechanical switch actuation). An operator may enter control parameters, instructions, or commands and select desired operating algorithms and features of the device 102 via user interface input 106. In one embodiment a display or indicator 108 is coupled to the controller 104 to display appropriate messages and/or indicators to the operator of the device 102 to confirm user inputs and operation of the device 102. A memory 110 is also coupled to the controller 104 and stores instructions, calibration constants, and other information as required to satisfactorily complete a selected user instruction or input. Memory 110 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

Power to control system 100 is supplied to controller 104 by a power supply 112 configured to be coupled to a power line L. Analog to digital and digital to analog converters (not shown) are coupled to the controller 104 to implement controller inputs and executable instructions to generate controller outputs to operative components 114, 116, 118 and 120 of the device 102 according to known methods. While four components 114, 116, 118, and 120 are illustrated in FIG. 1, it is recognized that greater or fewer components may be employed within the scope of the present invention.

In response to manipulation of the control interface 106, the controller 104 monitors various operational factors of the device 102 with one or more sensors or transducers 122, and the controller 104 executes operator selected functions and features according to known methods. In an exemplary embodiment, the controller 104 is programmed to respond appropriately to the outputs of a membrane switch assembly, and by virtue of the interface 106 and a separately provided touch controller 124, the device controller 104 may be used with more reliable touch-based sensor technology without adaptation of the device controller 104. The touch controller 124, as explained further below, emulates or simulates an output scheme of a membrane switch assembly in the interface 106 As such, the device controller 104 need not be reprogrammed, and the control interface 106, via the touch controller 124, provides a versatile and reliable drop-in replacement for a membrane switch assembly associated with the device 102. Retrofit installation of a touch-based control interface 106 to the system 102 is therefore provided.

Like the device controller 104, the touch controller 124 includes a microcomputer or other processor 126 coupled to the user control interface 106, and a memory 128 that stores instructions, calibration constants, control algorithms, and other information as required to satisfactorily interface with the device controller 104. Memory 128 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM). The controller 124 is programmed to emulate or simulate the control outputs of a membrane switch assembly in a transparent manner to the device controller 104.

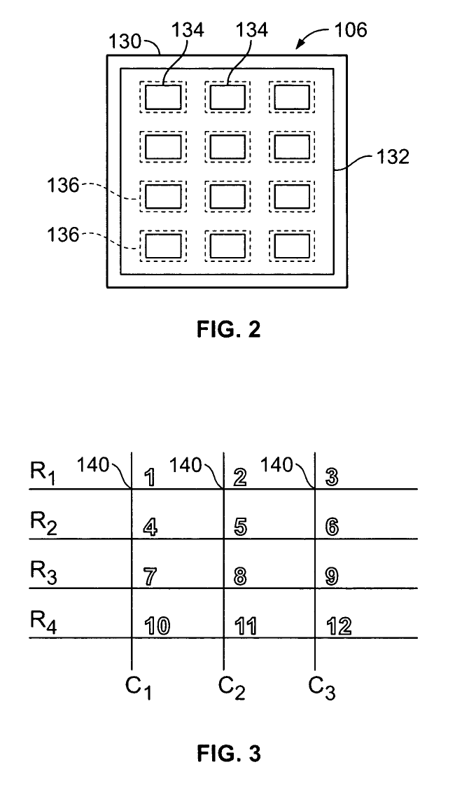

FIG. 2 is a top plan view of an exemplary control interface 106 for the control system 100 (shown in FIG. 1). The interface 106 includes a panel 130 which defines an interface area 132 for manipulation by a user to enter control commands and instructions for the device 102 (shown in FIG. 1). In different embodiments, the panel 130 may be mounted proximate the operative components 114-120 (e.g., dispensing components) of the device 102 (such as in a vending machine), or the panel 130 may be located in a remote location from the components 114-120 (such as for moving components of an industrial machine).

The panel 130 further includes touch sensitive areas 134 arranged in a grid, array or matrix form having a number of rows and a number of columns in an exemplary embodiment, such as for a numerical keypad. It is understood, however, that the touch sensitive areas 134 need not be physically aligned or arranged in a grid form in alternative embodiments of the interface 106, provided that, as explained below, the touch sensitive areas 134 are electrically connected in a matrix form having the desired number of inputs and outputs corresponding to the membrane switch which the interface 106 is designed to replace. While twelve touch sensitive areas 134 (corresponding to four rows and three columns of areas illustrated in FIG. 2) are provided in an illustrative embodiment, in alternative embodiments more or less touch sensitive areas 134 may be included in the interface area 106.

Associated with each of the touch sensitive areas 134 are touch sensitive elements 136 (shown in phantom in FIG. 2). The elements 136, and the controller 104 are configured to detect an actual touch, also referred to herein as a touch detection or touch result, at the associated touch sensitive areas 134. Unlike known switching elements (e.g., membrane switch assemblies), touches are detected electronically, and actual mechanical or electrical switching of a conductive path, and associated reliability issues thereof, is avoided.

In an exemplary embodiment, the touch sensitive elements 136 are capacitive touch sensors such as those described in U.S. Pat. No. 5,760,715, the disclosure of which is hereby incorporated by reference in its entirety. When the touch sensor system of U.S. Pat. No. 5,760,715 is employed as the touch sensitive elements 134, a touch may be detected when the touch sensitive elements 136 associated with the respective touch sensitive areas 134 issue a test pulse to earth ground and detects the return of the test pulse through the human user and through the touch sensitive area 134. In alternative embodiments, the touch sensitive elements 134 are infrared detectors, or other known tactile or touch-based sensors familiar to those in the art employing voltage sensing, current sensing and the like to detect a user activation of the touch sensitive area.

While one control interface 106 is illustrated having one exemplary matrix or array of keypads, it is understood that the control system 100 may have more than one control interface 106, and each control interface 106 may have one or more interface areas 132. Further, each interface area 132 may include more or less touch sensitive areas 134 corresponding to more or less touch sensitive elements 136 as shown in FIG. 2.

In operation, a user touches or otherwise contacts, such as with a finger, the touch sensitive areas 134 to enter a user command, instruction or input to the device controller 104 (shown in FIG. 1). The touch controller 124 processes the activation of the touch sensitive elements 136 and outputs signals to the device controller 104 in a form that the device controller 104 is configured to accept, such as the output form of a conventional membrane switch assembly. The device controller 104, in turn, operates the applicable components 114-120 of the device 102 in accordance with the user input. Further, and unlike known touch-based control interfaces, the touch controller 104 is configured to detect simultaneous activation of more than one of the touch sensitive elements 136 to enter, for example, diagnostic or programming modes of the device 102.

FIG. 3 schematically illustrates an input/output matrix for the control interface 106 using touch-based technology that emulates the output scheme of a conventional membrane switch matrix to the device controller 104 (FIG. 1).

As shown in FIG. 3, the touch sensitive elements 136, represented by the numeric characters 1-12, are arranged in a matrix grid having four rows and three columns corresponding to input rows and output columns of membrane switch keypads which they may replace. The intersection of the rows and columns may be considered a virtual switch point 140 for each of the touch sensitive elements that correspond to the switch points of the membrane switch which the present interface 106 is desired to replace. Input wires, terminals, or connections R₁, R₂, R₃, R₄, and output wires, terminals or connections C₁, C₂, C₃ connect the switch points. The switch points are deemed to be “virtual” in FIG. 3 because there is no physical connection of the input connections R₁, R₂, R₃, R₄, and the output connections C₁, C₂, C₃ in the interface 106, but rather the touch controller 124 (FIG. 1) monitors the individual touch sensitive elements 136, and based upon signals received from the device controller 104, the touch controller provides appropriate output signals at C₁, C₂, C₃ to mimic the behavior of a membrane switch. That is, in the example of FIG. 3, the touch controller 124 independently monitors each of the twelve touch sensitive elements individually for activation, and through the algorithms explained below, determines the output signals on C₁, C₂, C₃ that the membrane switch would have produced had the corresponding keys in the membrane switch been activated.

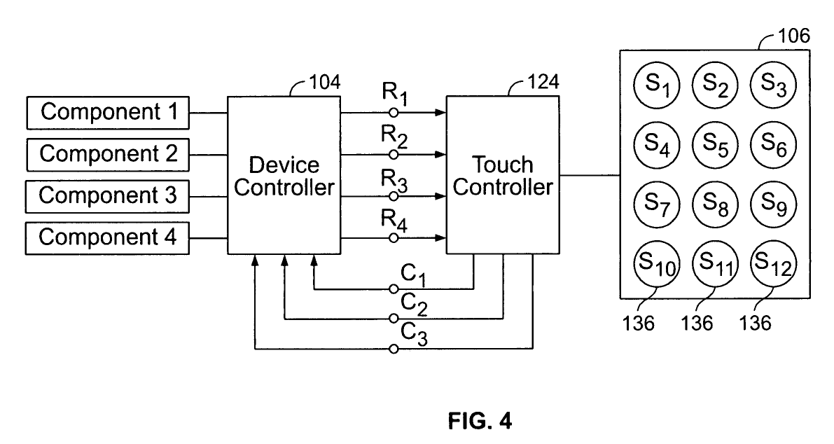

Referring now to FIG. 4, the input connections R₁, R₂, R₃, R₄ receive input strobes from the device controller 104 (FIG. 1) that were previously used to pulse the inputs of the membrane switch, and the output wires C₁, C₂, C₃ are scanned by the device controller 104 to detect signal outputs from the array. The touch controller 124 monitors the twelve touch sensitive elements 136 in the array (designated S₁ through S₁₂ in FIG. 4), and in response to the input strobes to R₁, R₂, R₃, R₄ the touch controller 124 outputs signals to C₁, C₂, C₃. That is, in the example of FIGS. 2, 3 and 4, the touch controller 124 receives control input signals to input connections of a first number (e.g., four), monitors touch sensitive elements of a different number (e.g., twelve), and outputs signals to connections of a third number (e.g., three). The device controller 104 operates exactly as it did with the membrane switch, and generates input signals to the first number of inputs (e.g., R₁, R₂, R₃, R₄), and reads output signals from the third number of outputs (e.g., C₁, C₂, C₃). The output signals are provided by the touch controller 104 without switching of any current path in the interface 106, yet the resultant output signals correspond exactly to what the membrane switch would have produced, or alternatively, the resultant output signals correspond to outputs that the virtual switch points 140 (FIG. 3) would produce to provide conductive paths between R₁, R₂, R₃, R₄ and C₁, C₂, C₃.

In an exemplary embodiment, input signals from the touch controller 124 are low strobes or pulses and in an exemplary embodiment are low active open collector strobes with passive pull-ups to allow signals to transfer row to row. Determining the output signals to outputs C₁, C₂, C₃ to emulate or simulate the outputs of the membrane switch is determined in an iterative fashion according to the following algorithm executable by the touch controller 124.

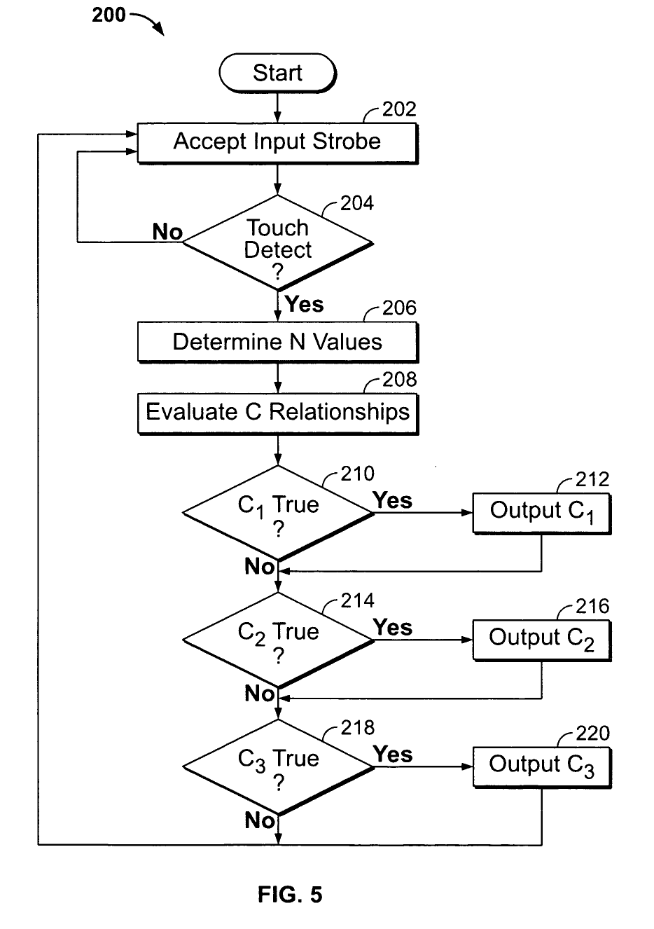

In an exemplary embodiment, and referring now to the algorithm 200 shown in FIG. 5, the touch controller accepts 202 the sequential input strobes to R₁, R₂, R₃, R₄ from the device controller, and the touch controller monitors the touch sensitive elements to detect 204 whether the touch sensors have been activated by a user. If no touch is detected 204, the touch controller continues to accept 202 the input strobes from the device controller and no further action is taken. Detection 204 of the touches is performed independently of the accepted input strobes by virtue of the touch control independently operating from the device controller, although as will be seen below, the output signals produced by the algorithm are responsive to, and dependent upon, the input strobes to simulate the outputs of a membrane switch in real time.

If a touch is detected 204 for one or more of the touch sensitive elements, the touch controller determines 206 intermediate values N according to the following logical relationships of Equations 1a to 1d:
N1=!R1 (Eq. 1a)
N2=!R2 (Eq. 1b)
N3=!R3 (Eq. 1c)
N4=!R4 (Eq. 1d)
where the symbol “!” may be recognized as a logical NOT operator and R1, R2, R3, and R4 represent a signal input to the respective connections R₁, R₂, R₃, R₄ initiated by the device controller 104 (FIG. 4). For purposes of explanation, potential states of R1, R2, R3, and R4 are either “high” or “low” corresponding to the presence or absence of a signal input to the respective inputs R1, R2, R3, and R4. In one embodiment, “high” corresponds to no signal input, and “low” corresponds to a signal input to the input connections R₁, R₂, R₃, R₄. The input strobes or pulse signals to R₁, R₂, R₃, R₄ are made in a sequential manner by the device controller 104, so R₁, R₂, R₃, R₄ are made “low” on a periodic basis, and otherwise remain “high”.

With a single key activation, N1 through N4 according to Equations 1a and 1b are constant, but with simultaneous key activations N1 through N4 are inter-related according to the following logical relationships.
N1=!R1 or (Eq. 2a)

(N2 and ((S1 and S4) or (S2 and S5) or (S3 and S6))) or

(N3 and ((S1 and S7) or (S2 and S8) or (S3 and S9))) or

(N4 and ((S1 and S10) or (S2 and S11) or (S3 and S12)))
N2=!R2 or (Eq. 2b)

(N1 and ((S4 and S1) or (S5 and S2) or (S6 and S3))) or

(N3 and ((S4 and S7) or (S5 and S8) or (S6 and S9))) or

(N4 and ((S4 and S10) or (S5 and S11) or (S6 and S12)))
N3=!R3 or (Eq. 2c)

(N1 and ((S7 and S1) or (S8 and S2) or (S9 and S3))) or

(N2 and ((S7 and S4) or (S8 and S5) or (S9 and S6))) or

(N4 and ((S7 and S10) or (S8 and S1 1) or (S9 and S12)))
N4=!R4 or (Eq. 2d)

(N1 and ((S10 and S 1) or (S 1I and S2) or (S 12 and S3))) or

(N2 and ((S10 and S4) or (S11 and S5) or (S12 and S6))) or

(N3 and ((S10 and S7) or (S11 and S8) or (S12 and S9)))

where Sₙ indicates activation of the corresponding touch sensitive element 136 in the interface, as best seen in FIG. 4.

Once Equations 2a to 2d are solved or determined 206, the values of N1, N2, N3 and N4 are input into the following equations to determine or evaluate 208 the corresponding outputs for C₁, C₂, C₃.
C1=(N1 and S1) or (N2 and S4) or (Eq. 3a)

(N3 and S7) or (N4 and S10)
C2=(N1 and S2) or (N2 and S5) or (Eq. 3b)

(N3 and S8) or (N4 and S11)
C3=(N1 and S3) or (N2 and S6) or (Eq. 3c)

(N3 and S9) or (N4 and S12)

If the logical operative statements of Equations 3a, 3b and 3c are true or satisfied for a given state of the values N1, N2, N3 and N4 from Equations 2a, 2b, 2c, and 2d, the touch controller provides an output signal to C₁, C₂, C₃ To provide a true membrane replacement, the output signals to C₁, C_{2 and C}₃ a re inverted prior to being communicated to the device controller 104 in an exemplary embodiment.

Thus, as shown in FIG. 5, the touch controller determines whether Equation 3a is true, and if so, the touch controller outputs 212 a signal to connection C₁. If the touch controller determines 210 that Equation 3a is not true, the touch controller determines 214 whether Equation 3b is true. If Equation 3b is true, the touch controller outputs 216 a signal to connection C₂. Likewise, if the touch controller determines 214 that Equation 3b is not true, the touch controller determines 218 whether Equation 3c is true. If Equation 3c is true, the touch controller outputs 220 a signal to connection C₃ and reverts back to accept 202 another input strobe. If Equation 3c is not true the touch controller reverts back to accept 202 another input strobe from the device controller 104.

By way of example, several scenarios will be explored for the algorithm 200. First, activation of a single touch sensitive element 136, for example sensor S1 in FIG. 4, causes the controller to conclude the following outcomes set forth in Table 1 when R₁ is set low by the device controller 104.

TABLE 1

| | |
|---|---|
| Equation 1a | N1 = !R1 = True |
| Equation 1b | False |
| Equation 1c | False |
| Equation 1d | False |
| Equation 2a | N1 = !R1 = True |
| Equation 2b | False |
| Equation 2c | False |
| Equation 2d | False |
| Equation 3a | C1 = N1 and S1 = True |
| Equation 3b | False |
| Equation 3c | False |

Therefore, as shown in FIG. 5, the touch controller outputs 212 a signal to C₁, but not to C_{2 or C}₃. When R2, R3, and R₄ a re made low, none of Equations 3a, 3b, or 3c will be true and the controller will revert to accept 202 inputs as shown in FIG. 5.

As another example, activation of multiple touch sensitive elements 136 in a single row, for example sensors S1 and S2 in FIG. 4, causes the touch controller to conclude the following outcomes set forth in Table 2 when R₁ is set low by the device controller 104.

TABLE 2

| | |
|---|---|
| Equation 1a | N1 = !R1 = True |
| Equation 1b | False |
| Equation 1c | False |
| Equation 1d | False |
| Equation 2a | N1 = !R1 = True |
| Equation 2b | False |
| Equation 2c | False |
| Equation 2d | False |
| Equation 3a | C1 = N1 and S1 = True |
| Equation 3b | C2 = N1 and S1 = True |
| Equation 3c | False |

Therefore, as shown in FIG. 5, the touch controller outputs 212 and 216 signals to C₁ and C₂, but not to C₃. When R2, R3, and R4 are made low, none of Equations 3a, 3b, or 3c will be true and the controller will revert to accept 202 inputs as shown in FIG. 5.

As a third example, activation of multiple touch sensitive elements 136 in a single column, for example sensors S₁ and S₇ in FIG. 4, causes the touch controller to conclude the following outcomes set forth in Table 3 when R₁ is set low by the device controller 104.

TABLE 3

| | |
|---|---|
| Equation 1a | N1 = !R1 = True |
| Equation 1b | False |
| Equation 1c | False |
| Equation 1d | False |
| Equation 2a | N1 = !R1 = True |
| Equation 2b | False |
| Equation 2c | N3 = N1 and (S7 and S1) = True |
| Equation 2d | False |
| Equation 3a | C1 = (N1 and S1) and (N3 and S7) = True |
| Equation 3b | False |
| Equation 3c | False |

Therefore, as shown in FIG. 5, the touch controller outputs 212 a signal to C₁, but not to C_{2 and C}₃. When R2 and R4 are made low, none of Equations 3a, 3b, or 2c will be true and the controller will revert to accept 202 inputs as shown in FIG. 5. When R3 is made low, the touch controller concludes the following outcomes set forth in Table 4

TABLE 4

| | |
|---|---|
| Equation 1a | False |
| Equation 1b | False |
| Equation 1c | True |
| Equation 1d | False |
| Equation 2a | N1 = N3 and (S1 and S7) = True |
| Equation 2b | False |
| Equation 2c | N3 = !R3 = True |
| Equation 2d | False |
| Equation 3a | C1 = (N1 and S1) and (N3 and S7) = True |
| Equation 3b | False |
| Equation 3c | False |

Therefore, the as shown in FIG. 5, the touch controller outputs 212 a signal to C₁, but not to C_{2 and C}₃, the identical result as when R₁ was made low.

It should now be evident that when sensors are activated in different columns and different rows, the touch controller will output signals to C₁, C_{2 and C}₃ in response to the input signals to R₁, R₂, R₃, R₄. In all circumstances, the touch controller will output signals to C₁, C_{2 and C}₃ corresponding exactly to the signals that the membrane switch assembly would have produced for a selected key or key combination, and when the device controller 104 reads the output signals, it may operate the device 102 without any modification or reprogramming whatsoever. Therefore, by disconnecting the inputs and outputs of the membrane switch and connecting them to the touch controller 124 as described above, an effective drop-in replacement control for membrane switches is provided. Devices 102 originally provided with switching interfaces can therefore be retrofitted with newer, more reliable, touch based control interfaces. Alternatively, using the above-described methodology, a device manufacturer may now provide multiple versions of devices with either a conventional switch matrix or a touch based control system, without changing the underlying product platform or configuration because both the conventional switch matrix and the touch based control system will have the same input and output connections to the product or device.

Having now described an exemplary control algorithm and several examples of its execution, it is believed that those in the art of programming electronic controllers could program the touch controller without further explanation. Furthermore, and as those in the art of electronic controllers will appreciate, the equations can be changed appropriately for positive going pulses and different numbers of rows and columns. Likewise, if the columns are desired for input scanning, similar equations can be expressed to output appropriate signals on the rows of the matrix array.

It is also recognized, that while one exemplary algorithm and accompanying equations have been proposed herein, further reduction of the equations is possible without departing from the basic principles of the invention. The foregoing is but one potential calculation scheme that may be employed in the present invention.

While the invention has been described in terms of various specific embodiments, those skilled in the art will recognize that the invention can be practiced with modification within the spirit and scope of the claims.

What is claimed is:

1. A touch controller for a touch sensitive control system having a control interface panel and a plurality of touch detecting elements, said controller configured to
accept a first number of input signals via corresponding input connections;
monitor each of said touch detecting elements individually to detect user touch activation thereof; and
output signals corresponding to detected touches, wherein a number of output signals is less than a number of touch detecting elements in the interface.

2. A touch controller in accordance with claim 1 wherein said controller is configured to accept a different number of input signals than corresponding output signals for detected touches.

3. A touch controller in accordance with claim 1 wherein said controller is configured to output signals corresponding to simultaneous activation of multiple touch detecting elements.

4. A touch controller in accordance with claim 1 wherein said controller is configured to emulate an output control scheme of a membrane switch assembly.

5. A touch controller in accordance with claim 1 wherein the touch sensitive control system includes a device controller, the touch controller configured to receive input signals from the device controller, and transmit output signals to the device controller based upon detected touch activations of the touch detecting elements.

6. A touch controller in accordance with claim 1 wherein said input signals are low strobes.

7. A touch controller in accordance with claim 1 wherein said touch detecting elements and said touch controller simulate switching elements electrically connected in a cross matrix, the matrix including a number of output connections that is different from the number of touch detecting elements.

8. A touch controller in accordance with claim 1 wherein the touch controller includes a first number of input connections, a second number of output connections, and monitors a third number of touch detecting elements, said first number and said second number each being different from said third number.

9. A control interface for a device having a device controller, said control interface comprising:
an interface panel defining a plurality of touch sensitive areas;
touch sensitive elements associated with each respective one of said touch sensitive areas; and
a touch controller individually monitoring each of the touch sensitive elements and outputting control signals to the device controller, wherein the touch controller emulates the control output scheme of a membrane switch.

10. A control interface in accordance with claim 9 wherein a number of output signals is less than a number of touch sensitive elements in the interface.

11. A control interface in accordance with claim 9 wherein said touch controller has a different number of input connections than output connections.

12. A control interface in accordance with claim 9 wherein said touch controller is configured to output signals corresponding to simultaneous activation of multiple touch detecting elements.

13. A control interface in accordance with claim 9 wherein said touch detecting elements and said touch controller simulate switching elements electrically connected in a cross matrix, the matrix including a number of input connections that is different from the number of touch detecting elements.

14. A control interface in accordance with claim 9 wherein the touch controller is configured to receive input signals from the device controller, and transmit output signals to the device controller based upon detected touch activations of the touch sensitive elements, the touch activations of the touch sensitive elements being independent of the input and output signals.

15. A control interface in accordance with claim 9 wherein said input signals are low strobes.

16. A control interface in accordance with claim 9 wherein said touch detecting elements and said touch controller simulate switching elements electrically connected in a cross matrix, the matrix including a number of output connections that is different from the number of touch detecting elements.

17. A control interface in accordance with claim 9 wherein the touch controller includes a first number of inputs, a second number of outputs, and monitors a third number of touch detecting numbers, said first number and said second number each being different from said third number.

18. A touch based control system comprising
a device having a device controller and a number of components operatively connected thereto; and
a control interface communicating with the device controller, said control interface comprising:
an interface panel defining a plurality of touch sensitive areas;
touch sensitive elements associated with each respective one of said touch sensitive areas; and
a touch controller individually monitoring each of the touch sensitive elements, and outputting control signals to the device controller in response to single touch detection activation of one of the touch sensitive elements and simultaneous touch detection of more than one of the touch sensitive elements.

19. A control system in accordance with claim 18 wherein said touch controller emulates an output control scheme of a membrane switch assembly.

20. A control system in accordance with claim 18 wherein said touch controller receives control input signals from the device controller to a first number of input connections, monitors a second number of touch sensitive elements, and outputs signals to the device control at a third number of connections, wherein said first number is different from said second number and said third number is different from said first number.
